(19) United States
(12) Patent Application Publication
(10) Pub. No.: US 2014/0204021 A1
(43) Pub. Date: Jul. 24, 2014

(54) EYEGLASSES TYPE OPERATION DEVICE, EYEGLASSES TYPE OPERATING SYSTEM AND ELECTRONIC DEVICES

(71) Applicant: OLYMPUS CORPORATION, Tokyo (JP)

(72) Inventors: Ryohei SUGIHARA, Tokyo (JP); Seiji TATSUTA, Tokyo (JP); Teruo TOMITA, Tokyo (JP)

(73) Assignee: OLYMPUS CORPORATION, Tokyo (JP)

(21) Appl. No.: 14/157,679

(22) Filed: Jan. 17, 2014

(30) Foreign Application Priority Data
Jan. 18, 2013 (JP) 2013-006937

(51) Int. Cl. G06F 3/01; G06F 3/041; G06F 3/16

(52) U.S. Cl. CPC G06F 3/012; G06F 3/167; G06F 3/013; G06F 3/041
USPC 345/156

(57) ABSTRACT

An eyeglasses type operation device comprises a frame configured to be worn on a head of a user, a sensor that outputs a detection signal by sensing, the sensor being disposed inside the frame and a connector operatively connected to the sensor to receive the detection signal, the connector being configured to detachably connect to an external electronic device, and the connector being configured to output the detection signal to the external electronic device when the external electronic device is connected to the connector.

This application claims priority to Japanese Patent Application No. 2013-006937 filed on Jan. 18, 2013, the contents of which are incorporated herein by reference in entirety.

### BACKGROUND

The present invention generally relates to an eyeglasses type operation device, an eyeglasses type operating system and electronic devices. Conventionally, an eyeglasses type wearable device which is mounted on a head of a user is known.

There was a technique of the eyeglasses type wearable device to be attached to a head of the user. JP-A-2010-91748 discloses the technology that by attaching a display device on the temples of the normal glasses, an eyeglasses type wearable device is achieved. JP-A-2012-8290 discloses the technology of an eyeglasses type wearable device in which a display device and processing circuits or battery are all built-in the frame of the eyeglasses type wearable device.

### SUMMARY

According to one aspect of the invention, there is provided an eyeglasses type operation device comprising: a frame configured to be worn on a head of a user; a sensor that outputs a detection signal by sensing, the sensor being disposed in the frame; and a connector operatively connected to the sensor to receive the detection signal, the connector being configured to detachably connect to an external electronic device, the connector being configured to output the detection signal to the external electronic device when the external electronic device is connected to the connector.

According to one aspect of the invention, there is provided an eyeglasses type operation system comprising: an eyeglasses type operation device; an external electronic device when the external electronic device is connected to the eyeglasses type operation device; and a transmitter configured to communicate with a communication connection electronic device; wherein the external electronic device sends a control signal of the communication connection electronic device to the communication connection electronic device based on the detection signal received by the external electronic device.

According to one aspect of the invention, there is provided an electric device comprising: a connector configured to removably connect to an eyeglasses type operation device, the eyeglasses type operation device being configured to be worn by a user, an output device; and a controller configured to control the output device; wherein the eyeglasses type operation device includes a sensor configured to output a detection signal by sensing; the connector configured to output the detection signal received from the sensor to the controller; and the controller configured to perform a control processing of the output device based on the detection signal.

### BRIEF DESCRIPTION OF THE DRAWINGS

FIG. 1 is a top plan view which shows an eyeglasses type operation device of the present embodiment from the top side.

FIGS. 2A and 2B show the eyeglasses type operation device of the present embodiment from the right side.

FIG. 3 is a detailed first constitution example of the eyeglasses type operation device of the present embodiment.

FIG. 4 is a detailed second constitution example of the eyeglasses type operation device of the present embodiment.

FIG. 5A and FIG. 5B are illustrations showing the attachment of an external electronic device in association with the second constitution example (FIG. 5A shows attachment to the right side and FIG. 5B shows attachment to the left side).

FIG. 6 is a detailed third constitution example of the eyeglasses type operation device of the present embodiment.

FIG. 7 is an illustration of the use of external electronic devices in association with the third constitution example.

FIGS. 8A and 8B are illustrations of a display device.

FIG. 9 is an illustration of a display control technique based on a detection signal from a sensor.

FIG. 10 is an illustration of a display control technique based on a detection signal from a sensor.

FIG. 11 is a first constitution block diagram of the eyeglasses type operation device of the present embodiment.

FIG. 12 is a second constitution block diagram of the eyeglasses type operation device of the present embodiment.

### DESCRIPTION OF EXEMPLARY EMBODIMENTS

Several aspects of the invention may provide an eyeglasses type operation device, an eyeglasses type operation system and an electric device that can enable the control processing of one or more external electronic devices by a sensor of a frame of the eyeglasses.

According to one embodiment of the invention, there is provided an eyeglasses type operation device comprising: a frame configured to be worn on a head of a user; a sensor that outputs a detection signal by sensing, the sensor being disposed in the frame; and a connector operatively connected to the sensor to receive the detection signal, the connector being configured to detachably connect to an external electronic device, the connector being configured to output the detection signal to the external electronic device when the external electronic device is connected to the connector.

According to this embodiment, the sensor which the eyeglasses type frame was provided with performs sensing movement and outputs a detection signal. And the detection signal from the sensor of the eyeglasses type frame comes to be output to the external electronic device(s) by a connection when the external electronic device are connected to one or more connectors of the eyeglasses type frame. Therefore, the provision of the eyeglasses type operation device enabling the control processing of one or more external electronic devices by the sensor which the eyeglasses type frame was provided with is enabled.

In the eyeglasses type operation device, the connector may be configured to output the detection signal from the sensor to the external electronic device as control information of the external electronic device. According to this embodiment, when the external electronic device is connected to the connector of the eyeglasses type frame, a detection signal from sensor of the eyeglasses type frame comes to be output to the external electronic device as control information of the external electronic device by a connector. Therefore, the external electronic device can perform various control processing as control information by the detection signal from the sensor.

In the eyeglasses type operation device, the external electronic device may comprise a display device, and the connector may output the detection signal from the sensor to the external electronic device as display control information of the display device.

According to this configuration, when the external electronic device is connected to the connector of the eyeglasses type frame, a detection signal from sensor of the eyeglasses type frame comes to be output as display control information of the display device of external electronic device. Thereby, using the detection signal from the sensor of the eyeglasses type frame, the display control of the display device of external electronic device can be performed.

In the eyeglasses type operation device, the sensor may comprise a motion sensor that detects a movement of the head of the user, and the connector may be configured to output a motion detection signal from the motion sensor as the display control information for controlling a display of the display device depending on the movement of the head of the user.

According to this configuration, movement of the head of the user is detected by the motion sensor which the eyeglasses type frame was provided with, and the display control of the display device which responded to movement of the head of the user by outputting the motion detection signal to the external electronic device is enabled.

In the eyeglasses type operation device, the sensor may comprise an image sensor that detects an eye movement of the user when wearing the eyeglasses type operation device, and the connector may be configured to output an image detection signal from the image sensor based upon the detected eye movement of the user as the display control information for controlling the display of the display device depending on the eye movement of the user.

According to this configuration, the movement of the eyes of the user is detected by the image sensor which the eyeglasses type frame was provided with, and the display control of the display device which responded to the movement of the eyes of the user by outputting the image detection signal to the external electronic device is enabled.

In the eyeglasses type operation device, the sensor may comprise an microphone that detects a voice of the user when wearing the eyeglasses type operation device, and the connector may be configured to output a voice detection signal from the microphone based upon the detected voice of the user as the display control information for controlling the display of the display device depending on the voice of the user.

According to this configuration, the voice of the user is detected by the microphone which the eyeglasses type frame was provided with, and the display control of the display device which responded to the voice of the user by outputting the sound detection signal to the external electronic device is enabled.

In the eyeglasses type operation device, the external electronic device may comprise a transmitter to communicate with a communication connection electronic device, and the connector may be configured to output the detection signal from the sensor as control information of the communication connection electronic device.

According to this configuration, when the external electronic device is connected to the connector of the eyeglasses type frame, a detection signal from the sensor of the eyeglasses type frame comes to be output as control information of the communication connection electronic device (e.g., via a communication connection by external electronic device). Therefore, the communication connection electronic device can perform various control processing as control information by the detection signal from the sensor.

In the eyeglasses type operation device, the external electronic device may comprise a battery, and the connector may be configured to receive electricity from the battery of the external electronic device and supply electricity to the sensor.

According to this configuration, by electricity from the battery which the external electronic device(s) are provided with, the sensor of the eyeglasses type frame is operated and outputs the detection signal from a connector and comes to be able to perform various control processing.

In the eyeglasses type operation device, the connector may comprise a first connector and a second connector, and each of the first connector and the second connector may be configured to output the detection signal from the sensor.

According to this configuration, when the external electronic device is connected to at least of the first connector and the second connector, it is able to perform the control processing of the external electronic device by a detection signal from the sensor of the eyeglasses type frame.

In the eyeglasses type operation device, the first connector may be configured to removably connect to the external electronic device; the second connector may be configured to removably connect to the external electronic device; the detection signal from the sensor may be output to the external electronic device through the first connector when the external electronic device is connected to the first connector; and the detection signal from the sensor may be output to the external electronic device through the second connector when the external electronic device is connected to the second connector.

According to this configuration, the user selects a side to connect the external electronic device to freely and comes to be able to use eyeglasses type operation device.

In the eyeglasses type operation device, the first connector may be configured to removably connect to a first external electronic device, and the second connector may be configured to removably connect to a second external electronic device, wherein the second external electronic device includes a functional component which is different from the first external electronic device.

According to this configuration, various kinds of external electronic devices may be connected to the eyeglasses type frame by various combinations depending on application and the situation and can use and can meet various applications and situations of the user.

In the eyeglasses type operation device, the first connector may be disposed in a first temple located on a right side of the frame of the eyeglasses type operation device, and the second connector may be disposed in a second temple located on a left side of the frame of the eyeglasses type operation device.

According to this configuration, the user comes to be able to select whether, for example, an external electronic device is connected to the right side and temple section or the left side and temple section.

Alternatively, the weight balance comes to be able to be maintained when external electronic devices are connected to the right side and the left side.

In the eyeglasses type operation device, the sensor may comprise a motion sensor that detects a movement of the user, and the connector may be configured to output a motion detection signal from the motion sensor to the external electronic device. According to this configuration, by the motion sensor which the eyeglasses type frame was provided with, the movement of the user is detected, and various applications comes to be able to use the detection signal in the external electronic device.

In the eyeglasses type operation device, the sensor may comprise an image sensor that picks up an image, and the connector may be configured to output an image detection signal from the image sensor to the external electronic device.

According to this configuration, an image is imaged by the image sensor which the eyeglasses type frame was provided with, and various applications come to be able to use the image detection signal in the external electronic device.

In the eyeglasses type operation device, the sensor may comprise a microphone, and the connector may be configured to output the image detection signal as a control information of the external electronic device to the external electronic device. According to this configuration, a sound is detected by the microphone which the eyeglasses type frame was provided with, and various applications comes to be able to use the sound detection signal in the external electronic device.

In the eyeglasses type operation device, the sensor may comprise at least one of: (a) a direction sensor; (b) a GPS sensor; (c) an illumination sensor; (d) a temperature sensor; (e) a radiation sensor; (f) a touch sensor; and (g) an infrared sensor; and the connector may be configured to output a detection signal from the at least one sensor to the external electronic device. Note that the sensor provided as a sensor is not limited to these sensors and can use various sensors other than these.

In the eyeglasses type operation device, the connector may be configured to be built in to the frame. According to this configuration, the connector is invisible from the outside.

The eyeglasses type operation device may further comprise one or more external electronic devices when the external electronic device(s) are connected to the eyeglasses type operation device, the external electronic device(s) being controlled by the detection signal from the sensor.

In another embodiment of the invention, there is provided an electric device comprising: the eyeglasses type operation device; the external electronic device when the external electronic device is connected to the eyeglasses type operation device; and a transmitter configured to communicate with a communication connection electronic device; wherein the external electronic device sends a control signal of the communication connection electronic device to the communication connection electronic device based on the detection signal received by the external electronic device.

According to this embodiment, when the external electronic device(s) are connected to the connection of the eyeglasses type operation device, a detection signal comes to be output to the communication connection electronic device. Therefore, the communication connection electronic device can perform various control processing as control information by the detection signal from the sensor.

In another embodiment of the invention, there is provided an electric device comprising: a connector configured to removably connect to an eyeglasses type operation device, the eyeglasses type operation device being configured to be worn by a user, an output device; and a controller configured to control the output device; wherein the eyeglasses type operation device includes a sensor configured to output a detection signal by sensing; the connector configured to output the detection signal received from the sensor to the controller; and the controller configured to perform a control processing of the output device based on the detection signal.

According to this embodiment, when electronic device(s) are connected according to other embodiments of the present invention to the connector of the eyeglasses type frame, a detection signal from sensor of the eyeglasses type frame comes to be output to electronic device by a connector. Therefore, the provision of the electronic device(s) which can perform the control processing using the sensor of the eyeglasses type frame is enabled.

Embodiments of the invention are described below. Note that the present embodiment described below does not limit subject matter of the present invention described in the claims. Note that all of constitution examples described in the present embodiment may not be required constituent features of the present invention.

1. Eyeglasses Type Operation Device

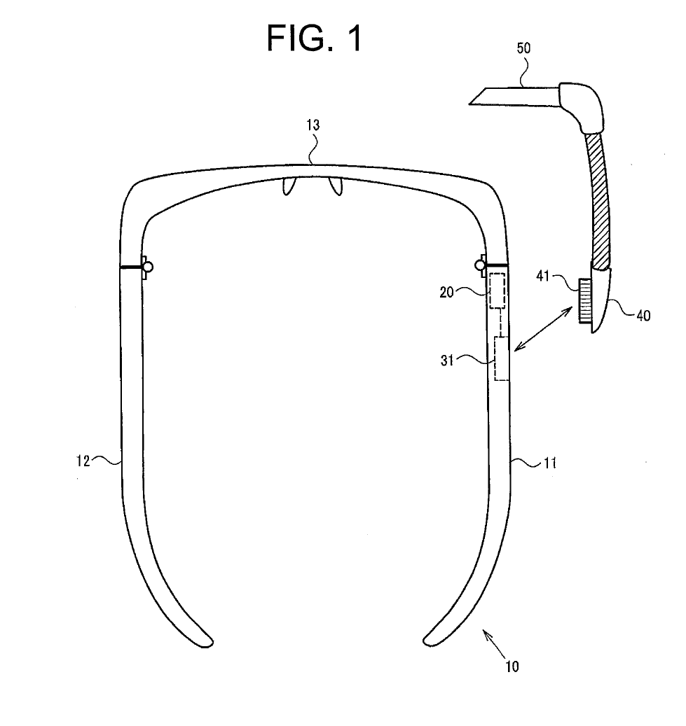

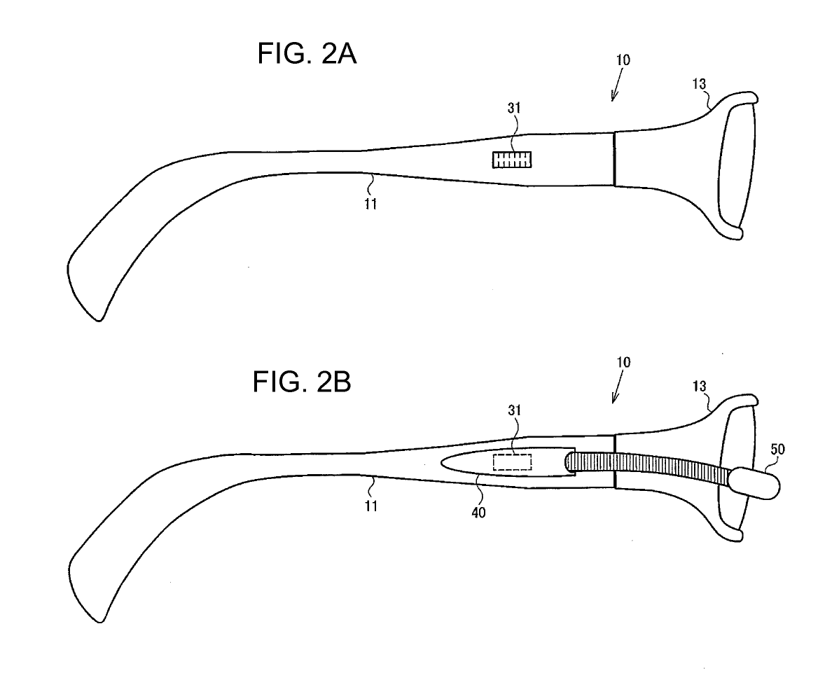

FIG. 1 is the top plan view which shows an eyeglasses type operation device of the present embodiment from the top side, and FIG. 2A, FIG. 2B are side views from the right side.

The eyeglasses type operation device (eyeglasses type wearable device) of the present embodiment includes an eyeglasses type frame 10 and a sensor 20 and a connector 31. An external electronic device 40 is connected to the connector 31. The eyeglasses type operating system (processing system) of the present embodiment can be constructed by the eyeglasses type operation device and the external electronic device 40 connected to the eyeglasses type operation device through the connector 31. External electronic device 40 is controlled by a detection signal from the sensor 20.

The eyeglasses type frame 10 is mounted on the head of the user and, for example, is a housing having the shape of glasses. The eyeglasses type frame 10 includes, for example, the first temple part 11 and second temple section 12 and the front part 13. Eyeglasses type operation device of the present embodiment is the eyeglasses type wearable device which a user can mount in wearable manner having the frame of the glasses shaped in this way.

It is first, and second temple part 11, 12 which correspond to temple or string of glasses. Specifically, the first temple part 11 is disposed along the right side of the head section of the user at the time of the wearing of the eyeglasses type operation device. Also, second temple part 12 is disposed along the left side of the head part of the user at the time of wearing.

The front part 13 is correspond to a rim and the bridge in so-called glasses and is disposed in front of the face (the front side of the face) of the user of the eyeglasses type operation device at the time of the wearing.

The sensor 20 is disposed in the eyeglasses type frame 10 and outputs a detection signal by the sensing (sensing signal). In FIG. 1 and FIGS. 2A,2B, first temple part 11 of the eyeglasses type frame 10 includes the sensor 20 built-in. Note that the sensor 20 may be built-in in second temple part 12 or the front part 13. In other examples, the sensor 20 may be attached to the eyeglasses type frame 10 first temple part 11, second temple part 12 or the front part 13.

The sensor 20 can be implemented by a sensor detecting the information of the peripheral environment of the users such as an image and/or the sound and/or a sensor detecting information of user oneself such as the movement of a face and/or the eye of the user. If it works in another way, the sensor 20 can be achieved by a sensor which outputs the detection signals as a detection signal of the control information of the external electronic device 40, or a sensor which outputs the detection signal as control information of an electronic device that is communicatively coupled to the external electronic device 40. For such a sensor, various kinds of sensors such as a motion sensor, image sensor, a microphone, a direction sensor, a GPS sensor, an illumination sensor, a temperature sensor, a radiation sensor, a touch sensor or the infrared sensor can be used, for example.

The connector 31 is disposed in the eyeglasses type frame 10 and is configured to detachably connect the external electronic device 40. In FIG. 1, and FIGS. 2A, B, the first temple part 11 of the eyeglasses type frame 10 is provided with the connector 31. Note that the connector 31 may be provided with the second temple part 12 and so on. For example, the connector 31 can be constructed by a component having a connector shape to connect detachably the external electronic device 40, an electrode or a signal line to perform a signal connection between the external electronic device 40 and the eyeglasses type operation device.

For example, in FIG. 1, by fitting between a connector shape member of the connector 41 of the external electronic device 40 and the connector shape member of the connector 31 of the sensor unit glasses-type operation device, the external electronic device 40 is mounted on the glasses-type control device. By this attachment, an electrode of connector 41 of the external electronic device 40 comes in contact with an electrode of the connector 31 of the eyeglasses type operation device. Therefore the exchanges of a signal (detection signal) and the voltage of the power source between the external electronic device 40 and eyeglasses type operation device are enabled.

FIG. 2A is a figure indicating the states when the external electronic device 40 is removed. On the side of the first temple part 11 of the eyeglasses type frame 10, it is provided with connector 31 of the connector shape. When the external electronic device 40 is not used, the eyeglasses type operation device can be used with the similar form of the normal eyeglasses in the points such as the designs of weight and the appearance by removing the external electronic device 40.

FIG. 2B is a figure indicating the states when the external electronic device 40 is attached. By connecting the external electronic device 40 to connector 31, the external electronic device 40 is supported in the eyeglasses type frame 10, and the use of it is enabled.

That is, in the present embodiment, the connector 31 outputs a detection signal from the sensor 20 to the external electronic device 40 connected to the connector 31. Specifically, the connector 31 outputs a detection signal from the sensor 20 to the external electronic device 40 as control information (operation information) of the external electronic device 40. Alternatively, the connector 31 outputs a detection signal from the sensor 20 as control information (operation information) of this the communication connection electronic device when the external electronic device 40 includes a communication section to communicate with the communication connection electronic device. Because the external electronic device 40 catches the detection signal (sensing signal) from the sensor 20 of the eyeglasses type operation device in this way, the eyeglasses type operation device can control (operate) the external electronic devices 40 and the communication connection electronic device.

For example, in FIG. 1 and FIG. 2A, B, the external electronic device 40 includes display device 50 such that virtual image observation of an image is possible. That is, the external electronic device 40 connected to the connector 31 of the first temple part 11 of the eyeglasses type operation device includes display device (display) 50 built-in. And through the emitted image light toward the eye of the user (wearer) by eyepiece optical system which extends to before one's eyes, the user is able to observe the virtual image observation of the image.

And in the present embodiment, the connector 31 outputs a detection signal from the sensor 20 to the external electronic device 40 as display control information of the display device (display). Thereby, display device 50 of the external electronic device 40 comes to be controlled based on a detection signal from the sensor 20 of the eyeglasses type operation device.

For example, a motion sensor (e.g., acceleration sensor, angular velocity sensor) detecting movement of the head of a user wearing the eyeglasses type operation device is possible for the sensor 20. In this case, the connector 31 outputs the motion detection signal from a motion sensor as display control information to display, which performs control of display device 50 depending on movement of the head of the user. Thereby, the display control that changes a display image or display embodiment of display device 50 depending on movement of the head of the user comes to be carried out.

Also, when an image sensor (e.g., CCD, CMOS sensor) imaging the image of the eyes (eyeball) of a user wearing the eyeglasses type operation device is provided as the sensor 20, the connector 31 outputs an image detection signal from image sensor as display control information to display. Thereby, the display control that changes a display image or display embodiment of display device 50 depending on the movement of the eyes of the user comes to be carried out.

Also, a microphone (e.g., sound detection sensor) detecting the voice of a user wearing eyeglasses type operation device as the sensor 20 is possible. In this case, the connector 31 outputs the sound detection signal (voice detection signal) from a microphone as display control information of the display device 50 depending on the voice of the user. Thereby, the display control that changes a display image or display embodiment of display device 50 depending on the voice of the user comes to be carried out.

A description is now made of various detailed kinds of constitution examples of the eyeglasses type operation device (and external electronic devices) of the present embodiment.

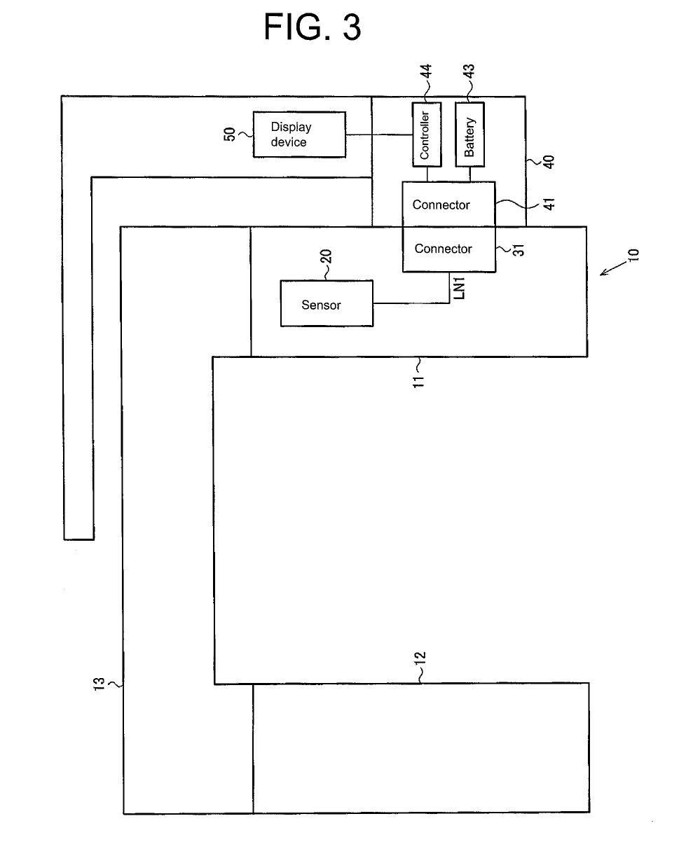

FIG. 3 is a figure which shows a detailed first constitution example of the eyeglasses type operation device (and external electronic devices) of the present embodiment. In FIG. 3, the first temple part 11 of the eyeglasses type frame 10 is provided with the sensor 20, and the connector 31 is provided with the side part. And the sensor 20 and the connector 31 are connected by tie line LN1. The connector 31 receives a detection signal output by the sensor 20 through this tie line LN1 and outputs the detection signal to an external electronic device 40.

The external electronic device 40 includes connector 41, battery 43, the controller 44, and the display device 50. Connector 41 of the external electronic device 40 is connected to the connector 31 of the eyeglasses type operation device. As well as the connector 31, the connector 41 can be constructed by a component having a connector shape to connect detachably the external electronic device 40 to the eyeglasses type operation device, and having an electrode or a signal line to perform a signal connection between the external electronic device 40 and the eyeglasses type operation device.

According to this configuration, the external electronic device 40 includes the controller 44, performing control processing of an output section (device), the connector 41 to be connected to the eyeglasses type operation device detachably and the output section (device) of the display device 50 and so on. The eyeglasses type operation device includes the sensor 20 for outputting a detection signal by sensing. The connector 41 receives a detection signal from the sensor 20 of the eyeglasses type operation device and outputs the detection signal to the controller 44, and the controller 44 performs the control processing of the output based on the detection signal.

The display device 50 (in a wide sense an output) is connected to the controller 44 and is controlled by the controller 44. By supplying voltage of the power source from battery 43 (e.g., battery, rechargeable battery), the controller 44 and the display device 50 work. The controller 44 (processing component) can be implemented, for example, by processors such as CPU's or exclusive ASIC.

By connecting to the connector 31 of the eyeglasses type operation device, the external electronic device 40 is used. And electricity may be supplied to the eyeglasses type operation device side from battery 43 of the external electronic device 40 by the external electronic device 40 being connected to the connector 31 and operates the sensor 20 of the eyeglasses type operation device by the electricity. That is, the connector 31 receives electricity from battery 43 of the external electronic device 40 and supplies electricity to the sensor 20. The sensor 20 receives this electricity from the connector 31 through tie line LN1 and performs sensing movement and outputs a detection result as a detection signal.

The detection signal from the sensor 20 is output to the external electronic device 40 through the connector 31 and is processed by the controller 44 of the external electronic device 40. Thereby, control processing (operation) is enabled with the external electronic device 40 using the eyeglasses type operation device. For example, movement of the head of the user is detected by the sensor 20 (e.g., motion sensor) and the display control is performed based on the detection signal, thereby the display control responded to movement of the head is enabled when the external electronic device 40 includes the display device 50 built-in like FIG. 3. Alternatively, based on a detection signal (e.g., motion detection signal) from the sensor 20 (e.g., motion sensor), various correction such as the blurring correction disposal of display images of the display device 50 may be processed.

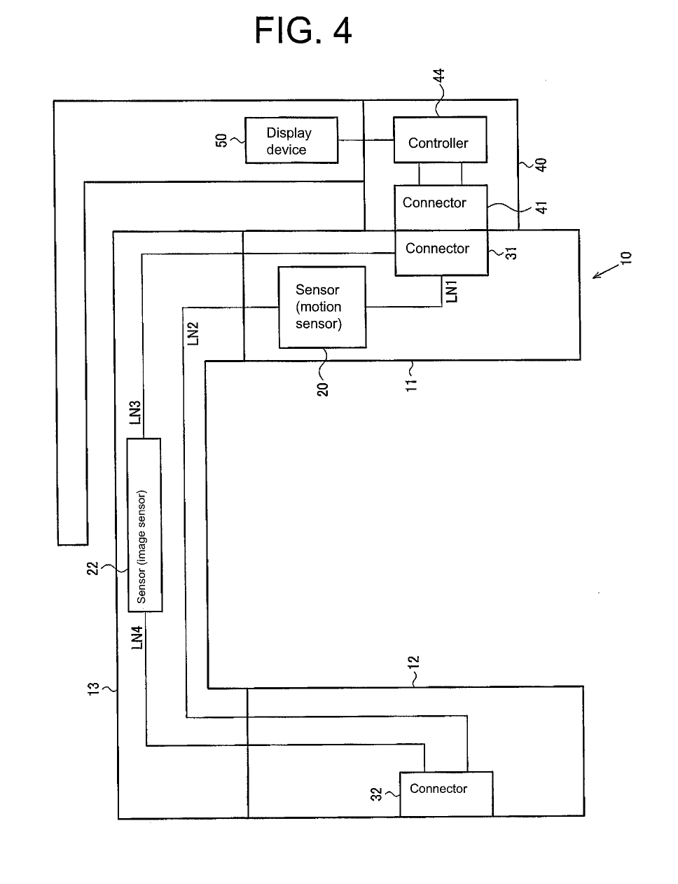

FIG. 4 shows a detailed second constitution example of the eyeglasses type operation device (and external electronic devices) of the present embodiment. In the second constitution example of FIG. 4, it is provided with, the first connector 31, the second connector 32 as a connector. Specifically, the first temple part 11 on the right side of the eyeglasses type frame 10 is provided with the connector 31, and the second temple section 12 on the left hand side of the eyeglasses type frame 10 is provided with connector 32. Thereby, the user can freely select a side to connect the external electronic device 40. Note that it may allow it to connect external electronic devices having a different main function part in right and left to the first connector 31, the second connector 32.

Also, in FIG. 4, the eyeglasses type frame 10 is provided with a plurality of sensors parts. Specifically, the first temple part 11 is provided with the sensor 20, and the front part 13 is provided with sensor 22. For example, by the sensor 20 (e.g., a motion sensor) disposed on the first temple part 11, sensing of movement of the head of the user is performed. On the other hand, sensing of the movement of the eyes of the user is performed with sensor 22 (e.g., image sensor) disposed in the front part 13, thereby it can be possible that display control and pointing with the external electronic device 40 is provided.

And the detection signal from the sensor 20 is output by the connector 31, 32 both. The detection signal from sensor 22 is output by the connector 31, the connector 32 both, too. Specifically, each of the connector 31 and the connector 32 is connected to the sensor 20 and by each connection line LN1, LN2. Also, each of the connector 31 and the connector 32 is connected to sensor 22 by each tie line LN3, LN4. The connector 31 receives the detection signal from the sensor 20, 22 through each connection line LN1, LN3 and outputs the detection signal to external electronic device 40. Also, connector 32 receives the detection signal from the sensor 20, 22 and outputs through connection line LN2, LN4 and outputs the detection signal to external electronic device 40.

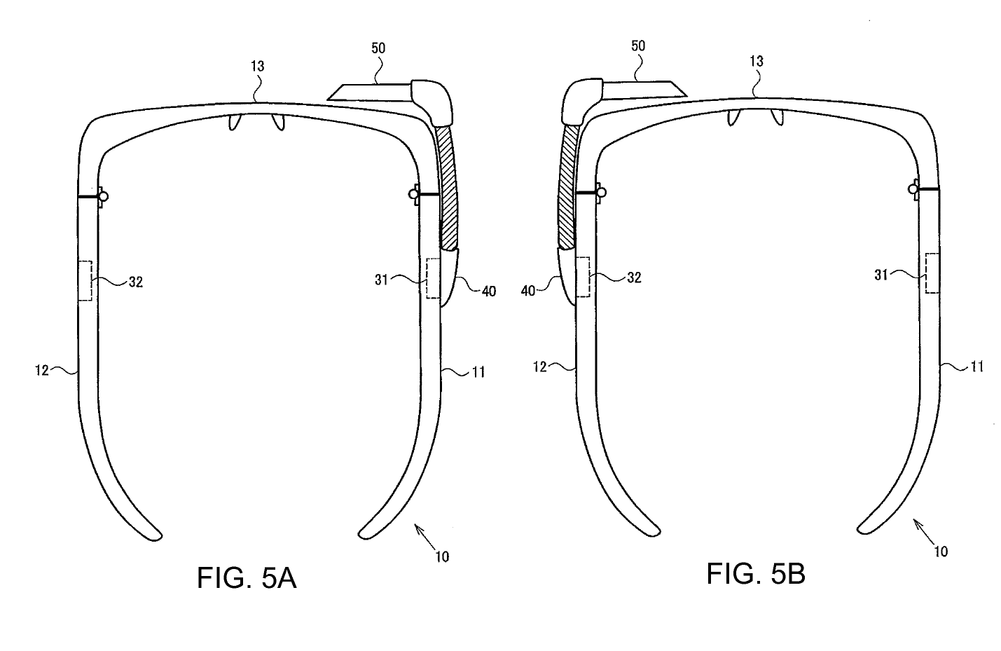

FIG. 5A, FIG. 5B are figures showing attachment of the external electronic device 40 in the second constitution example of FIG. 4. In the second constitution example, the connector 31 is a connector that can detachably connect to the external electronic device 40 and the connector 32 is a connector that can detachably connect to the external electronic device 40.

When the external electronic device 40 connects to the connector 31 like FIG. 5A, the detection signal from the sensor 20, the sensor 22 are output to the external electronic device 40 through the connector 31. On the other hand, when the external electronic device 40 connects to the connector 32 like FIG. 5B, the detection signal from the sensor 20, the sensor 22 are output to the external electronic device 40 through the connector 32.

In FIG. 4 and FIG. 5A, 5B, the detection signal from the sensor 20, the sensor 22 is output from both right and left connector 31,32 in this way. Therefore, even if a user connects the external electronic device 40 to the connector 31 or 32 (whichever), the external electronic device 40 using the eyeglasses type operation device can be controlled similarly.

For example, the user wishing to see an image of the display device 50 of the external electronic device 40 with the right eye connects the external electronic device 40 to the right connector 31 like FIG. 5A. And when the head is moved and performs movement such as moving eyes, this movement is detected by the sensor 20,22 of the eyeglasses type operation device and display control of the display device 50 of the external electronic device 40 connected to the right connector 31 is performed. On the other hand, when the external electronic device 40 is connected to the left connector 32 like FIG. 5B, and the user wishing to see an image of the display device 50 of the external electronic device 40 in a left eye moves the head and performs movement such as moving eyes. Thereby, display control of the display device 50 of the external electronic device 40 connected to the left connector 32 comes to be carried out.

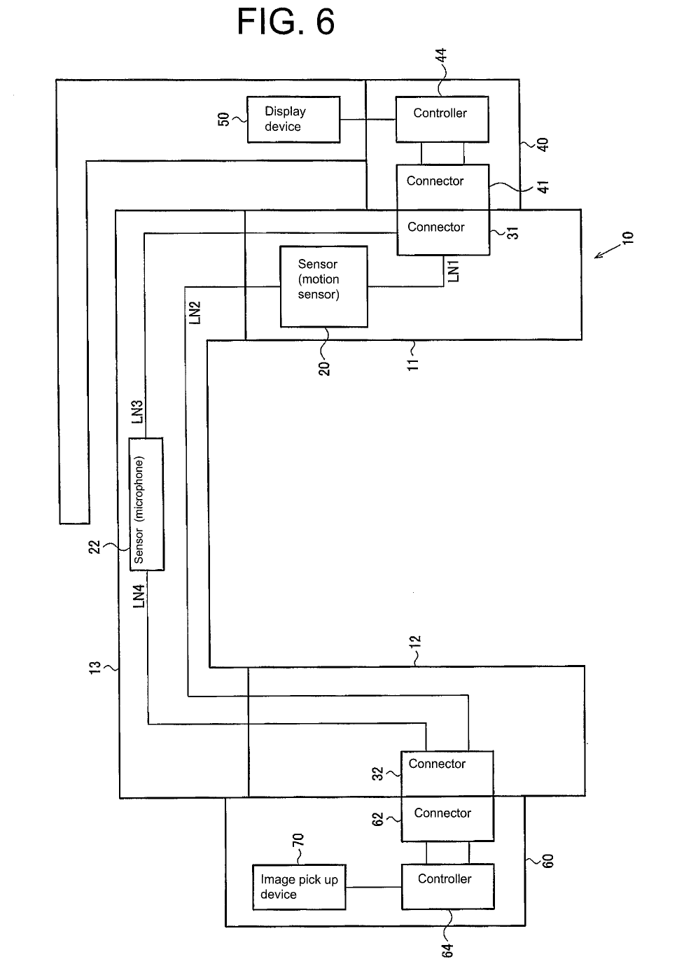

A detailed third constitution example of the eyeglasses type operation device (and external electronic devices) of the present embodiment is shown in FIG. 6. Even a third constitution example of FIG. 6 is provided with first, second connector 31, 32 as a connector. And the connector 31 is a connector that can detachably connect to the first external electronic device 40. The connector 32 is a connector that can detachably connect to second external electronic device 60 having at least one functional part which is different from first external electronic device 40. In this way, Thus the user can exchange use of external electronic devices and/or use in combination various external electronic devices depending on application and the situation by allowing connection of various external electronic devices 40, 60 having different main function.

For example, in FIG. 6, the external electronic device 40 connected to the connector 31 on the right side of the eyeglasses type operation device is an electronic device having a display function. Specifically, the external electronic device 40 includes connector 41, the controller 44 and the display device 50. The display device 50 can comprise display area and its drive. Connector 41 is connected to the connector 31 of the eyeglasses type operation device, and the controller 44 controls the display device 50.

On the other hand, external electronic device 60 connected to connector 32 on the left hand side of the eyeglasses type operation device is an electronic device having an imaging function. Specifically, external electronic device 60 includes connector 62, the controller 64, and image pickup device 70. Connector 62 is connected to connector 32 of the eyeglasses type operation device, and the controller 64 controls imaging device 70. Imaging device 70 can comprise optical system(s) to image with image sensor (imaging element) and the image sensor such as, for example, CCD, CMOS sensor.

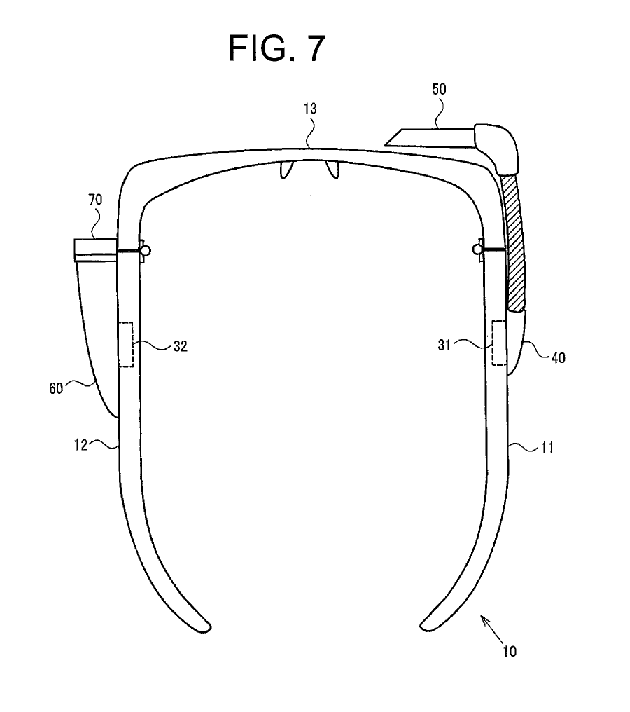

According to this configuration, as shown in FIG. 7, the external electronic device 40 having an display function is connected to the right connector 31 and external electronic device 60 having a imaging function is connected to left connector 32. Thereby the use that cooperated mutually is enabled. That is, the provision of the contents that interlocked the display device 50 with imaging device 70 is enabled. For example, a real-time image imaged by imaging device 70 of left external electronic device 60 can be displayed on the display device 50 of right external electronic device 40. In another example, image recognition processing can be performed to an image imaged by imaging device 70 of external electronic device 60 and the image based on the result of this image recognition processing can be displayed on the display device 50 of the external electronic device 40. For example, the signboards which a foreign letter was written by imaging device 70 are imaged and a process for image recognition of the foreign letter may be provided, wherein an application such as displaying a translation result provided by image recognition processing to the display device 50 is enabled.

Note that, from the sensor 20, 22 which the eyeglasses type frame 10 had built-in, a detection signal is output to the external electronic devices 40, 60. Thereby, the external electronic devices 40, 60 share these sensors 20, 22 and can use information.

In the glasses type control device of the present embodiment described above, a sensor such as an electrical sensor that is convenient to be placed in the glasses side is placed on the glasses type frame unit. Furthermore, the connector is disposed in the eyeglasses type frame and allows the connector to connect and use the external electronic devices which had main function parts such as processing system and/or the battery. That is, by having sensors built-in in the eyeglasses type frame, a function as the manipulation interface which detects the states of movement of the head and/or the movement of eyes and/or the living body is given to the eyeglasses type frame. And, the operation control of the external electronic devices which were connected is implemented by connecting external electronic devices having a main function part to the connector of the eyeglasses type frame.

For example, as for normal glasses which do not have sensors built-in, it is a problem that there is low degree of freedom about the placement of the sensors. For example, as for sensors like an image sensor to detect a line of sight and a sensor like a pulse sensor which is used to touch the human body, it is desirable that the sensor is attached to the glasses frame rather than the external electric device.

In the present embodiment, as for the sensors which are desired to be provided with the eyeglasses type operation device, the sensors can be disposed on the eyeglasses frame section. Thereby, the degree of freedom about the placement of the sensors can be raised. On the other hand, the glasses type operation device can achieve the processing which is performed based on the detection signals from the sensors. As for the functional components for realizing the imaging function and display function, the glasses type operation device may use those functional components built in the external electronic device. Then, the glasses type operation device with sensors controls the external electronic device connected to the glasses type operation device.

Thereby, when the equipment is not in use, by removing the external electronic device, it is possible to use the glasses type control device in the conditions similar to normal eyeglasses. Further, since the external electronic apparatus having main functional components costly and the like are detachable, when a plurality of types of glasses type control devices having different designs and different ones of the power of the lens are prepared, it becomes possible to reduce the cost.

That is, when all needed functional components are built in the eyeglass frame, the weight of the glasses type wearable device is increased compared to normal glasses. It leads to inhibit the convenience of the user. For example, if a user can not use functional objects built-in eyeglass frame unit and the weight is increased by the functional objects, it is meaningless and useless for the user. Further, in order to enhance the merchantability and functionality as glasses, a plurality of types that are different designs and have different power of the lens are desired. Further, providing various electronic devices whose functional components are different as the external electronic device, it is possible to replace various external electronic devices or use an external electronic device and various external electronic devices in combination depending on the situation or application.

In this regard, according to the eyeglasses-type control device of the present embodiment, sensors are provided on the glasses type frame, the major functional components are provided in the external electronic device and are controlled on the basis of the detection signal, for example. Therefore, it is sufficient weight only by providing a light sensor such as the spectacle-type frame, it is possible to suppress the weight increase of the spectacle-type control device. Further, in order to be connected with the connector of the eyeglasses type frame unit, an external electronic device having a functional object itself is desired, without causing increase in the weight of the eyeglasses type control device, it is possible to meet various demands of the user. Further, even when a plurality of types that are different designs and have different power of the lens are prepared, it requires only cost increase by the sensor, and the like, thereby achieving cost reduction.

Also, in the present embodiment, sensors are disposed in the eyeglasses type frame. Therefore, it is enabled to dispose pulse sensors to come into contact with the human body, and to use on the part coming in contact with the human body. That is, only mounting it comes to be able to acquire necessary information.

Also, in the present embodiment, the sensors such as an acceleration sensor or the angular velocity sensor to detect posture of the head are built-in to the eyeglasses type operation device which are always mounted stably at the same position to the head. Simplification of improvement and the calibration processing of the detection accuracy can be planned by doing it this way. That is, the eyeglasses type operation device of the present embodiment is attached to the same position with stable posture to the head of the user like normal glasses. Therefore, the sensors such as acceleration sensors disposed in the eyeglasses type frame come to be disposed at the same position to the head of the user stably. Therefore, simplification of improvement and the calibration processing of the detection accuracy can be planned because placement posture of sensors becomes constant.

Also, the eyeball image which is always appropriate can be stably acquired by placing a function of imaging an eyeball to detect a line of sight on the eyeglasses type frame side. Also, external electronic equipment can be attached selectively near a side that a user wishes for by providing the connectors in right and left.

Also, providing various electronic devices whose functional components are different as the external electronic device, it is possible to replace various external electronic devices or use an external electronic device and various external electronic devices in combination depending on the situation or application. For example, it is possible to use external electronic apparatus having a photographing function and an external electronic device having a display function in combination. And the control processing of the external electronic device is performed by a detection signal from a sensor provided in the glasses type frame unit.

Besides, if an apparatus having an imaging function is connected on the left hand side of the eyeglasses type frame, and an apparatus having an display function is connected on the right side of it, the use that cooperated mutually is enabled. For example, it can make a real-time image imaged by a left-sided imaging function display by the right display function.

2. Display Device, Display Control Technique

A description is now made of an example of a display device used in the present embodiment and display control technique thereof.

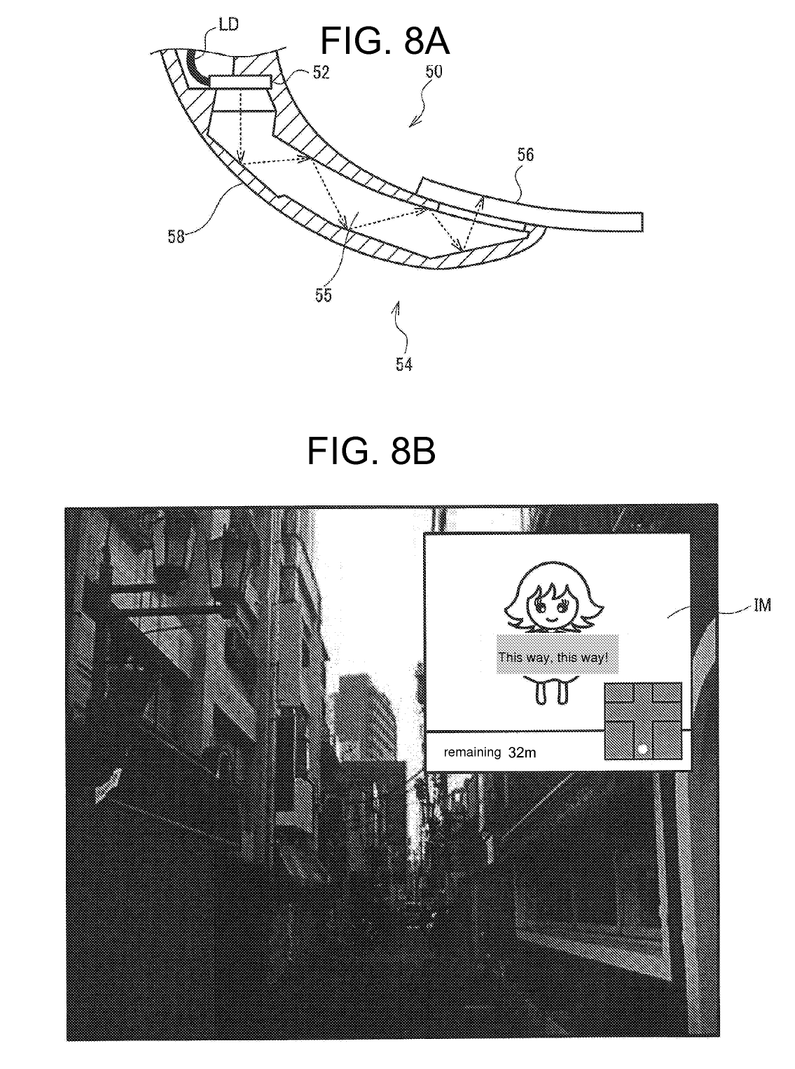

The display device 50 is attached to the external electronic device 40 in FIG. 8 A. This display device 50 includes display 52 and eyepiece optical system 54 and support member 58.

The display 52 (indicating element) is implemented by, e.g., LCD or OLED, and displays various images. The display 52 is connected electrically by the tie line LD to a drive device in the external electronic device 40, and is driven to be displayed. The eyepiece optical system 54 is an optical system that a user can observe an image of display area 52 as a virtual image. The eyepiece optical system 54 is constructed by optical components such as light guiding unit 55 and eyepiece window 56. Image light from display area 52 is guided in eyepiece window 56 by light guiding unit 55 of eyepiece optical system 54. The support member 58 is the member that performs support (placement) of eyepiece window 56 of eyepiece optical system 54 before the right eye of the user or the left eye of the user. This support member 58 is bendable, and the user can adjust a position of eyepiece window 56 by making support member 58 bent.

As shown in FIG. 8B, displaying by HMD (Head Mounted Display) of the see-through type is enabled by using the display device 50 of FIG. 8A. That is, an image IM generated by the display device 50 can be superimposed to display in a part of the view of the user. In FIG. 8B, it is superimposed in a part of the view of the user that an image IM for navigation guided to a user is displayed. The display device 50 used for the present embodiment is not limited to the constitution of FIG. 8A, and various kinds of constitution is possible.

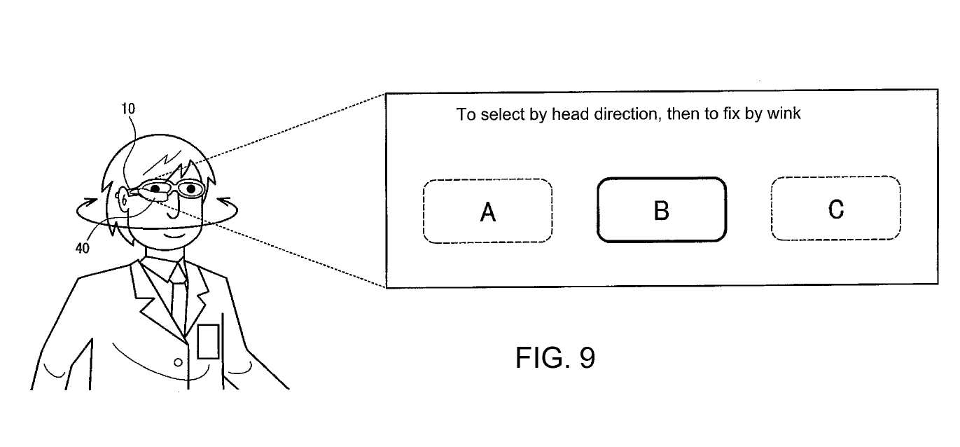

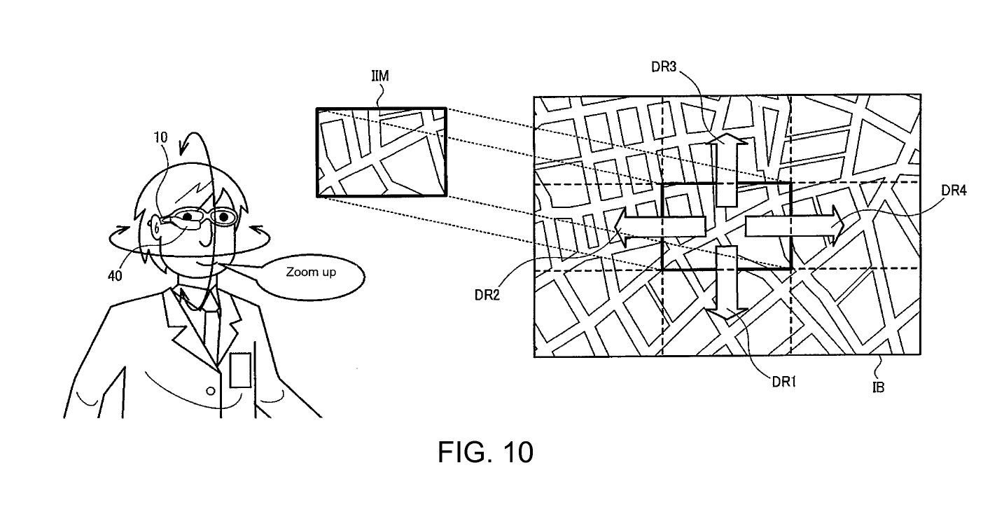

FIG. 9 and FIG. 10 are figures describing various kinds of display control technique based on the detection signal from the sensor.

In FIG. 9, the eyeglasses type frame 10 is provided with image sensor imaging the image of the eyes of the user and a motion sensor (acceleration sensors) detecting movement of the head of the user. By the motion detection signal from a motion sensor, the display control of the display device of the external electronic device 40 is carried out depending on movement of the head of the user. Also, by an image detection signal from image sensor, the display control of the display device is carried out depending on the movement of the eyes of the user. For example, in FIG. 9, when a user performs movement to wag the head in right and left, this movement is detected by a motion sensor. And, as shown in FIG. 9, display control for a user to select the item which own wishes for is carried out. Also, the movement of these eyes is detected by image sensor when a user blinks its eyes after selecting an item. And display control to determine selection of the item which a user selected is carried out.

In FIG. 10, the eyeglasses type frame 10 is provided with a motion sensor detecting movement of the head of the user and microphone detecting the voice of the user. And, by the motion detection signal from a motion sensor, the display control of the display device is carried out depending on movement of the head of the user. Also, by the sound detection signal from a microphone, the display control of the display device is carried out depending on the voice of the user. For example, this movement is detected by a motion sensor when a user performs movement to wag the head up and down and left and right in FIG. 10. And, as shown in FIG. 10, image IIM which is really displayed by the display device is selected from image memory area IB of a display buffer based on the detection result of the motion sensor. For example, an extraction zone of image IIM moves as shown in direction DR1-DR4 when a user wags the head up and down and left and right. And the voice is detected by a microphone, and it is recognized when a user generates, for example, voices such as “the zoom up” as a voice inputting command. And display control to perform zoom up of the image which was selected, for example, at the time of voice generation is carried out.

Because the eyeglasses type operation device of the present embodiment is put on like normal glasses, in the case of display control such as FIG. 9, FIG. 10, the relative positional relationship of the motion sensor to the head of the user is fixed to some extent. Therefore, the simplification of calibration processing and improvement of the detection accuracy of the motion sensor can be planned. Also, an image and the voice of the eyes of the user come to be able to be detected easily by, for example, the microphone detecting the voice of the user and the image sensor imaging the eyes of the user disposed in the front parts of the eyeglasses type operation device. Therefore, there is an advantage that can simply implement display control such as FIGS. 9 and 10 with high precision.

3. Constitution Block Diagram

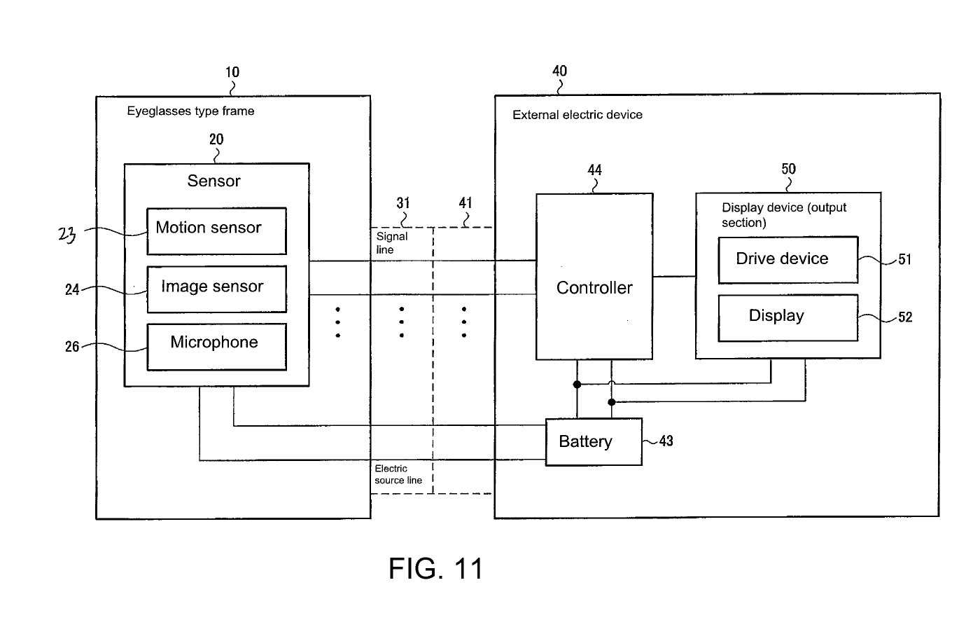

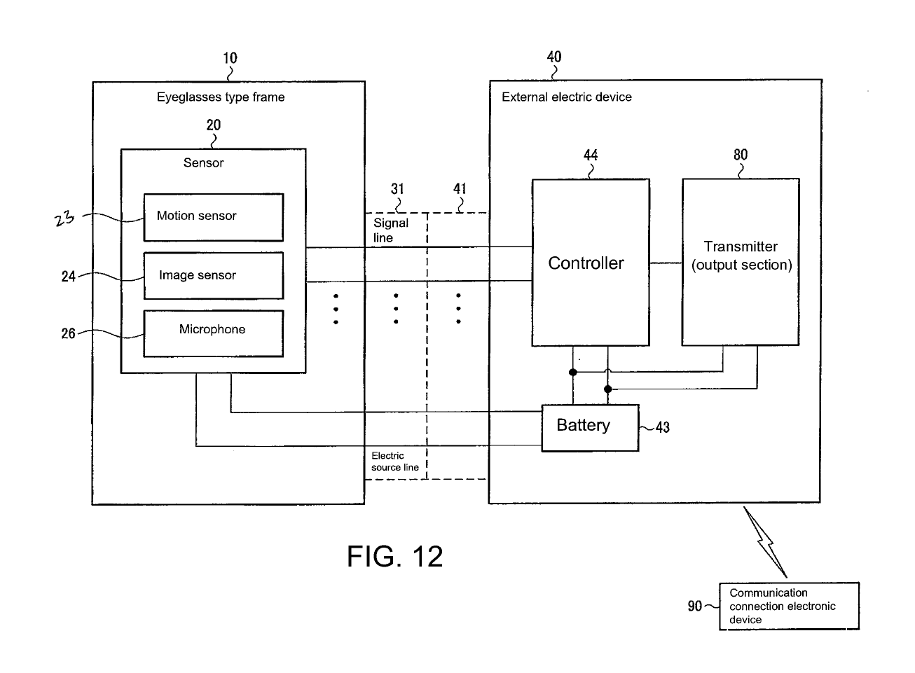

FIG. 11, FIG. 12 are constitution block diagrams which show the connection of each block of the eyeglasses type operation device of the present embodiment and external electronic device.

In FIG. 11, the eyeglasses type frame 10 of the eyeglasses type operation device is provided with the sensor 20, and the sensor 20 includes motion sensor 23, image sensor 24, microphone 26, and various other sensors. On the other hand, the external electronic device 40 includes battery 43, the controller 44, the display device 50 (in a wide sense an output section).

Sensing of posture and movement of the head of the user can be performed by the motion sensors 23 such as acceleration sensors for the sensor 20, and the display control that worked with posture and movement of the head of the user is enabled. Also, when the image sensor 24 is disposed, imaging external world view of the user, sensing the situation of the place where a user is, and the operation by eyes based on imaging the eyes of the user are enabled. Also, when the microphone 26 is disposed, sensing a circumference sound of the user and utterance content of the user is enabled. Thereby, controlling combined with sound recognition together depend on the sensing can be possible.

When the external electronic device 40 is connected to the eyeglasses type frame 10, the detection signal from the sensor 20 is conveyed to the controller 44 through the connector 31, 41 signal lines. Also, the voltage of the power source from battery 43 is supplied to the sensor 20 through the connector 31, 41 power source lines. Motion sensor 23, image sensor 24 and microphone 26 of the sensor 20 work based on supplied voltage of the power source and output the detection signal to the controller 44. For example, a motion detection signal from motion sensor 23, image detection signal (image information) from image sensor 24, and a sound detection signal from microphone 26 are input into the controller 44. The controller 44 takes various processing based on these motion detection signals, image detection signal, sound detection signal and controls the display device 50 as the output section. And the display device 50 includes drive device 51 and display 52. The drive device 51 performs display drive of the display 52 under the control of the controller 44, and the display control that was thereby described in connection with FIG. 9, FIG. 10 is implemented.

For example, the battery relatively has heavy weight. Therefore, the weight of the eyeglasses type wearable apparatus gets heavy needlessly when it makes the eyeglasses type frame have battery built-in.

In this regard, with the eyeglasses type operation device of the present embodiment, battery 43 is disposed to the external electronic device 40 not to the eyeglasses type frame 10. Therefore, the demerit of the weight increase of battery 43 doesn't happen when the eyeglasses type frame 10 is used like normal glasses without connecting the external electronic device 40. Thereby, the convenience of the user can be improved. In this case, there is not the movement detection because voltage of the power source is not supplied to the sensor 20 of the eyeglasses type frame 10, but because the external electronic device 40 to which is the detection signal used is not connected, the problem doesn't happen. It is also rational. And when a user wants to use functions of the external electronic device 40, the external electronic device 40 is connected to the eyeglasses type frame 10 and then the sensor 20 can be performed by voltage of the power source of battery 43 of the external electronic device 40. Thereby, the sensor 20 can use functions of the external electronic device 40 using the detection signal.

Note that the sensor to provide for the sensor 20 is not limited to motion sensor 23, image sensor 24, microphone 26. For example, a direction sensor, a GPS sensor, an illumination sensor, a temperature sensor, a radiation sensor, a touch sensor and/or an infrared sensor may be provided for the sensor 20.

A direction or the line of the face of the user can be pinpointed by providing the direction sensor. Geomagnetic sensors can be used, for example, for a direction sensor. The location information of the user can be acquired by providing the GPS sensor.

The environmental information such as states of brightness and temperature and the radioactivity around the user can be acquired by providing an illumination sensor and a temperature sensor and the radiation sensor. For an illumination sensor, photodiode can be used. For a temperature sensor, thermistor can be used, for example. For a radiation sensor, the photodiode which converts an aerial radiation into an electric current can be used.

If a touch sensor is provided in the eyeglasses type frame 10, based on operation information input using this touch sensor, various control processing of the external electronic device 40 can be implemented. The sensors such as a resistor film method, a capacitance method, the electromagnetic induction method can be used for a touch sensor. Even in darkness an object can be seen by providing an infrared sensor. A far-red light line sensor or a far infrared ray sensor can be used for an infrared sensor.

In FIG. 12, the external electronic device 40 is provided with a communications section 80 (in a wide sense an output section). And the communications section 80 (e.g., transmitter) performs communication processing between the external communication connection electronic device 90 under the control of the controller 44. For example, communication processing such as short distance radio or the long-distance radio is performed. According to this configuration, the detection signal from various sensors of the sensor 20 which the eyeglasses type frame 10 had built-in comes to be able to be transmitted by radio to external the communication connection electronic device 90. Therefore, using the eyeglasses type operation device of the present embodiment, the control processing on the communication connection electronic device 90 becomes able to be implemented, too.

Here, for the communication connection electronic device 90, various apparatuses such as a Smartphone, cellular telephone, a portable terminal such as portable game player and a PC and a household appliance apparatus or the server apparatuses can be used, for example.

For example, the communications section 80 performing short distance wireless communication is disposed in the external electronic device 40. And a sensed signal from the sensor 20 of the eyeglasses type operation device is sent to the communication connection electronic device 90 by this short distance wireless communication. The communication connection electronic device 90 works to operate based on a received detection signal and performs various kinds of arithmetic processing, display control processing and sound control processing. When the communication connection electronic device 90 is a portable terminal, display of the display area is controlled and the output control of the sound is performed. Alternatively, the analysis processing of detection signal may be performed. When the communication connection electronic device 90 is a household appliance apparatus, using a detection signal from the sensor 20, various control processing such as the remote control of the household appliance apparatus is performed, for example. When the communication connection electronic device 90 is a server apparatus, based on a detection signal of the sensor 20, various analysis processing and operation processing are performed in a server apparatus.

Note that a part of or most of the processing of the operation devices and the electronic devices of the present embodiment may be implemented by a program. In this case, the operation devices and the electronic devices of the present embodiment are implemented by the processors such as CPU's that execute a program. Specifically, a program stored by a non-temporary information storage medium is read, and the processors such as CPU's perform a read of the program. Here, the information storage medium (the medium which is readable by a computer) stores a program or data, and the function can be implemented by an Optical Disk (DVD, CD), a HDD (hard disk drive), a memory (memory integrated circuit) or storage device (card type memory, ROM). And the processors such as CPU perform various kinds of processing of the present embodiment based on a program (data) stored by an information storage medium. That is, an information storage medium stores a program (program to make a computer perform processing of each section) to functionalize a computer (operating member, processing component, memory, device and comprising the output) as each section of the present embodiment.

Although some embodiments according to the invention have been described above, note that the invention is not limited to the some embodiments. Various modifications and variations may be made of the elements without departing from the scope of the invention. A plurality of elements of each of the some embodiments may be appropriately combined. For example, some of the elements described above in connection with the some embodiments may be omitted. The elements described in connection with different embodiments may be appropriately combined. Specifically, various modifications and applications are possible without materially departing from the novel teachings and advantages of the invention.

What is claimed is:

1. An eyeglasses type operation device, comprising:
a frame configured to be worn on a head of a user;
a sensor that outputs a detection signal by sensing, the sensor being disposed in the frame; and
a connector operatively connected to the sensor to receive the detection signal, the connector being configured to detachably connect to an external electronic device, the connector being configured to output the detection signal to the external electronic device when the external electronic device is connected to the connector.

2. The eyeglasses type operation device according to claim 1, wherein the connector is configured to output the detection signal from the sensor to the external electronic device as control information of the external electronic device.

3. The eyeglasses type operation device according to claim 1, wherein the external electronic device comprises a display device, and
the connector is configured to output the detection signal from the sensor to the external electronic device as display control information for controlling a display of the display device.

4. The eyeglasses type operation device according to claim 3, wherein the sensor comprises a motion sensor that detects a movement of the head of the user, and
the connector is configured to output a motion detection signal from the motion sensor as the display control information for controlling a display of the display device depending on the movement of the head of the user.

5. The eyeglasses type operation device according to claim 3, wherein the sensor comprises an image sensor that detects a movement of an eye of the user when wearing the eyeglasses type operation device, and
the connector is configured to output an image detection signal from the image sensor as the display control information for controlling the display of the display device depending on the movement of the eye of the user.

6. The eyeglasses type operation device according to claim 3, wherein the sensor comprises a microphone that detects a voice of the user when wearing the eyeglasses type operation device, and
the connector is configured to output a voice detection signal from the microphone based upon the detected voice of the user as the display control information for controlling the display of the display device depending on the voice of the user.

7. The eyeglasses type operation device according to claim 1, wherein the external electronic device comprises a transmitter to communicate with a communication connection electronic device, and
the connector is configured to output the detection signal from the sensor as control information of the communication connection electronic device.

8. The eyeglasses type operation device according to claim 1, wherein the external electronic device comprises a battery, and
the connector is configured to receive electricity from the battery of the external electronic device and supply electricity to the sensor.

9. The eyeglasses type operation device according to claim 1, wherein the connector comprises a first connector and a second connector, and
each of the first connector and the second connector is configured to output the detection signal from the sensor.

10. The eyeglasses type operation device according to claim 9, wherein:
the first connector is configured to removably connect to the external electronic device;
the second connector is configured to removably connect to the external electronic device;
the detection signal from the sensor is output to the external electronic device through the first connector when the external electronic device is connected to the first connector; and
the device signal from the sensor is output to the external electronic device through the second connector when the external electronic device is connected to the second connector.

11. The eyeglasses type operation device according to claim 9, wherein the first connector is configured to removably connect to a first external electronic device, and
the second connector is configured to removably connect to a second external electronic device, wherein the second external electronic device includes a functional component which is different from the first external electronic device.

12. The eyeglasses type operation device according to claim 9, wherein the first connector is disposed in a first temple located on a right side of the frame of the eyeglasses type operation device, and
the second connector is disposed in a second temple located on a left side of the frame of the eyeglasses type operation device.

13. The eyeglasses type operation device according to claim 1, wherein the sensor comprises a motion sensor that detects a movement of the user, and
the connector is configured to output a motion detection signal from the motion sensor to the external electronic device.

14. The eyeglasses type operation device according to claim 1, wherein the sensor comprises an image sensor that picks up an image, and
the connector is configured to output an image detection signal from the image sensor to the external electronic device.

15. The eyeglasses type operation device according to claim 14, wherein the connector is configured to output the image detection signal as a control information of the external electronic device to the external electronic device.

16. The eyeglasses type operation device according to claim 1, wherein the sensor comprises a microphone, and
the connector is configured to output a sound detection signal from the microphone to the external electronic device.

17. The eyeglasses type operation device according to claim 1, wherein the sensor comprises at least one of: (a) a direction sensor; (b) a GPS sensor; (c) an illumination sensor; (d) a temperature sensor; (e) a radiation sensor; (f) a touch sensor; and (g) an infrared sensor; and
the connector is configured to output a detection signal from the at least one sensor to the external electronic device.

18. The eyeglasses type operation device according to claim 1, wherein the connector is configured to be built in to the frame.

19. The eyeglasses type operation device according to claim 1, further comprising the external electronic device when the external electronic device is connected to the eyeglasses type operation device, the external electronic device being controlled by the detection signal from the sensor.

20. An eyeglasses type operation system comprising:
the eyeglasses type operation device according to claim 1;
an external electronic device when the external electronic device is connected to the eyeglasses type operation device; and
a transmitter configured to communicate with a communication connection electronic device;
wherein the external electronic device sends a control signal of the communication connection electronic device to the communication connection electronic device based on the detection signal received by the external electronic device.

21. An electronic device comprising:
a connector configured to removably connect to an eyeglasses type operation device, the eyeglasses type operation device being configured to be worn by a user,
an output device; and
a controller configured to control the output device; wherein
the eyeglasses type operation device includes a sensor configured to output a detection signal by sensing;
the connector configured to output the detection signal received from the sensor to the controller; and
the controller configured to perform a control processing of the output device based on the detection signal.
